(19) United States
(12) Patent Application Publication
(10) Pub. No.: US 2016/0372976 A1
(43) Pub. Date: Dec. 22, 2016

(54) POWER TRANSMITTING APPARATUS, POWER RECEIVING APPARATUS, CONTROL METHODS THEREFOR, AND COMPUTER-READABLE STORAGE MEDIUM

(71) Applicant: CANON KABUSHIKI KAISHA, Tokyo (JP)

(72) Inventor: Hajime Shimura, Yokohama-shi (JP)

(21) Appl. No.: 14/893,884

(22) PCT Filed: Aug. 1, 2014
(86) PCT No.: PCT/JP2014/070958

§ 371 Date: Nov. 24, 2015

(30) Foreign Application Priority Data
Aug. 22, 2013 (JP) 2013-172659

(51) Int. Cl. H02J 50/12; H02J 7/04; H02J 7/02; H02J 50/80; H02J 50/90

(52) U.S. Cl. CPC H02J 50/12; H02J 50/80; H02J 50/90; H02J 7/025; H02J 7/042; H02J 2007/0001

(57) ABSTRACT

The impedance value of an antenna for performing wireless power transfer with a power receiving apparatus is detected. When a change in the impedance value is detected, wireless power transfer with the power receiving apparatus is stopped.

### TECHNICAL FIELD

The present invention relates to a wireless power transfer system for wirelessly transferring power and, more particularly, to control of a power transmitting apparatus having a wireless communication function and a power receiving apparatus having a wireless communication function.

### BACKGROUND ART

Methods of wirelessly transferring power include an electromagnetic induction method, a magnetic resonance method, a capacitive coupling method, and a radio wave method. In the electromagnetic induction method and the magnetic resonance method, power is transferred using coupling between coils mounted in respective devices. In the capacitive coupling method, power is transferred using coupling between electrodes mounted in respective devices. In the radio wave method, radio waves are transmitted and received between antennas mounted in respective devices, thereby transferring power.

A wireless power transfer system may be configured to have a wireless communication function. In this case, it has been proposed to commonly use a coil in wireless communication and wireless power transfer (for example, Japanese Patent Laid-Open No. 2010-284065).

There has been proposed a charging apparatus capable of, when charging a plurality of electronic devices, appropriately charging the devices in accordance with the user's intention or usage in a wireless power transfer system (for example, Japanese Patent Laid-Open No. 2010-22105).

There has been also proposed a non-contact power transfer apparatus configured to prevent power transmission from starting or stopping power transmission in a case wherein a failure of ID authentication for a power transmitting target or a foreign substance including an electric conductor or magnetic material existing near a device is detected, a case wherein the position of a power receiving side device is inappropriate, a case wherein removal or the like of a power receiving side device is detected during power transmission, or a case wherein a charging operation ends (for example, Japanese Patent Laid-Open No. 2010-284006).

In a wireless power transfer system having a wireless communication function, at the time of charging/power supply from a power transmitting apparatus to a plurality of power receiving apparatuses, the plurality of power receiving apparatuses cannot be appropriately charged or supplied with power unless the power transmitting apparatus and the power receiving apparatuses are appropriately controlled. In such wireless power transfer system, if a coil mounted in each of the power transmitting apparatus and power receiving apparatuses is commonly used in wireless power transfer and wireless communication, it is necessary to appropriately process whether to handle electromagnetic waves input from the coil as communication or power, thereby requiring a complicated circuit.

### SUMMARY OF INVENTION

The present invention provides a power transmitting/receiving technique of allowing charging and power supply to a plurality of power receiving apparatuses by appropriately controlling a power transmitting apparatus and the power receiving apparatuses.

To achieve the above object, a power transmitting apparatus according to the present invention has the following arrangement. That is, a power transmitting apparatus for wirelessly transmitting power, comprising: an antenna which performs wireless power transfer with a power receiving apparatus; detection means for detecting an impedance value of the antenna; and control means for, when the detection means detects a change in the impedance value, stopping wireless power transfer with the power receiving apparatus.

According to the present invention, in a wireless power transfer system having a wireless communication function of charging and supplying power to a plurality of power receiving apparatuses from a power transmitting apparatus, it is possible to charge and supply power to a plurality of power receiving apparatuses by appropriately controlling the power transmitting apparatus and power receiving apparatuses. Furthermore, in the wireless power transfer system, if a coil is commonly used in wireless power transfer and wireless communication, it is possible to perform wireless power transfer and wireless communication without requiring any complicated circuit to separate electromagnetic waves input from the coil.

Further features of the present invention will become apparent from the following description of exemplary embodiments with reference to the attached drawings.

### BRIEF DESCRIPTION OF DRAWINGS

FIG. 1 is a view showing an example of the arrangement of the magnetic resonance method;

FIG. 2 is a view showing a power transmitting apparatus and power receiving apparatuses;

FIG. 3 is a flowchart illustrating control of the power transmitting apparatus;

FIG. 4 is a flowchart illustrating control of the power receiving apparatus;

FIG. 5 is a block diagram showing a circuit arrangement when an antenna is commonly used in NFC and wireless power transfer; and

FIG. 6 is a flowchart illustrating control of a power receiving apparatus.

### DESCRIPTION OF EMBODIMENTS

Embodiments of the present invention will be described in detail below with reference to the accompanying drawings.

### First Embodiment

The first embodiment assumes a wireless power transfer system using the magnetic resonance method, in which wireless power transfer and wireless communication are performed via a coil. Note that the present invention is applicable not only within the range of the magnetic resonance method but also to a wireless power transfer system of another method using coupling between coils or coupling between electrodes.

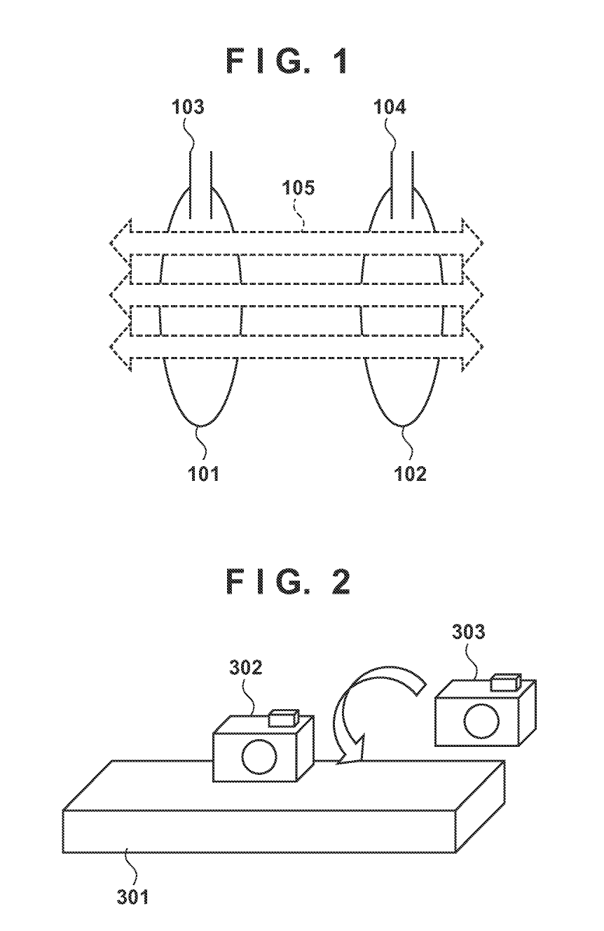

FIG. 1 is a view showing an example of the arrangement of the magnetic resonance method as one of wireless power transfer methods according to the first embodiment. In the magnetic resonance method, a coil and a matching circuit (capacitance) form an LC resonator to generate a resonance phenomenon, and a power transmitting apparatus and a power receiving apparatus are coupled, thereby transferring power. Reference numeral 101 denotes a power transmitting side coil of a power transmitting apparatus; 102, a power receiving side coil of a power receiving apparatus; 103, a power transmitting side matching circuit; 104, a power receiving side matching circuit; and 105, a magnetic flux.

In the magnetic resonance method, even if the distance (positional relationship) between the coil 101 of the power transmitting apparatus and the coil 102 of the power receiving apparatus changes, it is possible to transfer power at high efficiency by appropriately controlling the values of the matching circuits 103 and 104 respectively connected to the coils. Note that only one of the power transmitting side matching circuit and the power receiving side matching circuit may be controlled. A combination of the coil and matching circuit will be referred to as an antenna hereinafter.

In recent years, a wireless communication standard using a coil, which is called NFC (Near Field Communication), is incorporated in various products.

The first embodiment assumes a wireless power transfer system which has NFC serving as a wireless communication function, and a wireless power transfer function using the magnetic resonance method. Note that the invention is applicable not only within the range of NFC but also to another wireless communication method, such as Bluetooth and wireless LAN. Further, an antenna used for the wireless communication function may be a dipole antenna, a monopole antenna, an inverted F antenna, and the like.

FIG. 2 is a view showing an example of the configuration of the wireless power transfer system according to the first embodiment.

Reference numeral 301 denotes a power transmitting apparatus; 302, a power receiving apparatus A; and 303, a power receiving apparatus B. As the power receiving apparatus A 302 and the power receiving apparatus B 303, mobile devices such as a digital camera and smartphone each incorporating a battery are used. It is possible to place a plurality of power receiving apparatuses on the power transmitting apparatus 301. Assume that the power receiving apparatus A 302 has already been placed on the power transmitting apparatus 301, and the power transmitting apparatus 301 is wirelessly transferring power to the power receiving apparatus A 302. In this state, the power receiving apparatus B 303 is newly placed on the power transmitting apparatus 301.

Assume that each of the power receiving apparatus A 302 and the power receiving apparatus B 303 incorporates a battery, and stores power received from the power transmitting apparatus 301 in the battery. Assume also that each of the power transmitting apparatus 301, the power receiving apparatus A 302, and the power receiving apparatus B 303 includes different antennas for NFC serving as a wireless communication function and a wireless power transfer function using the magnetic resonance method.

In the arrangement shown in FIG. 2, the power transmitting apparatus 301 is wirelessly transferring power to the power receiving apparatus A 302. However, the power transmitting apparatus 301 may preferentially charge and supply power to the power receiving apparatus B 303 over the power receiving apparatus A 302. Even if the power transmitting apparatus 301 continues to charge and supply power to the power receiving apparatus A 302, when the power receiving apparatus B 303 is moved close to the power transmitting apparatus 301 and the power receiving apparatus A 302, the impedances of the antennas of the power transmitting apparatus 301 and the power receiving apparatus A 302 may shift, thereby disabling high-efficiency wireless power transfer.

To solve such a problem, in the first embodiment, the following functions are incorporated in the power transmitting apparatus and the power receiving apparatuses, and controlled.

The power transmitting apparatus 301 incorporates an antenna impedance detection function of detecting the antenna impedance of the power transmitting apparatus 301. This function detects the impedance by, for example, connecting a direction coupler to the antenna, extracting power which is reflected by the antenna when power is input to the antenna, and measuring the value of the power.

Each of the antennas of the power transmitting apparatus 301, the power receiving apparatus A 302, and the power receiving apparatus B 303, which is used to wirelessly transfer power, has a function of changing or adjusting the corresponding matching circuit. More specifically, the matching circuit uses circuit elements (for example, a resistor, capacitor, and inductor), and controls to change or adjust the constants of the resistor, capacitor, and inductor.

Note that each of the power transmitting apparatus 301, the power receiving apparatus A 302, and the power receiving apparatus B 303 includes hardware components (a CPU, memories (RAM and ROM), a display unit, an input unit, and the like) mounted in a general computer, in addition to the above function. Furthermore, the above function can be implemented when, for example, the CPU executes a program stored in the memory.

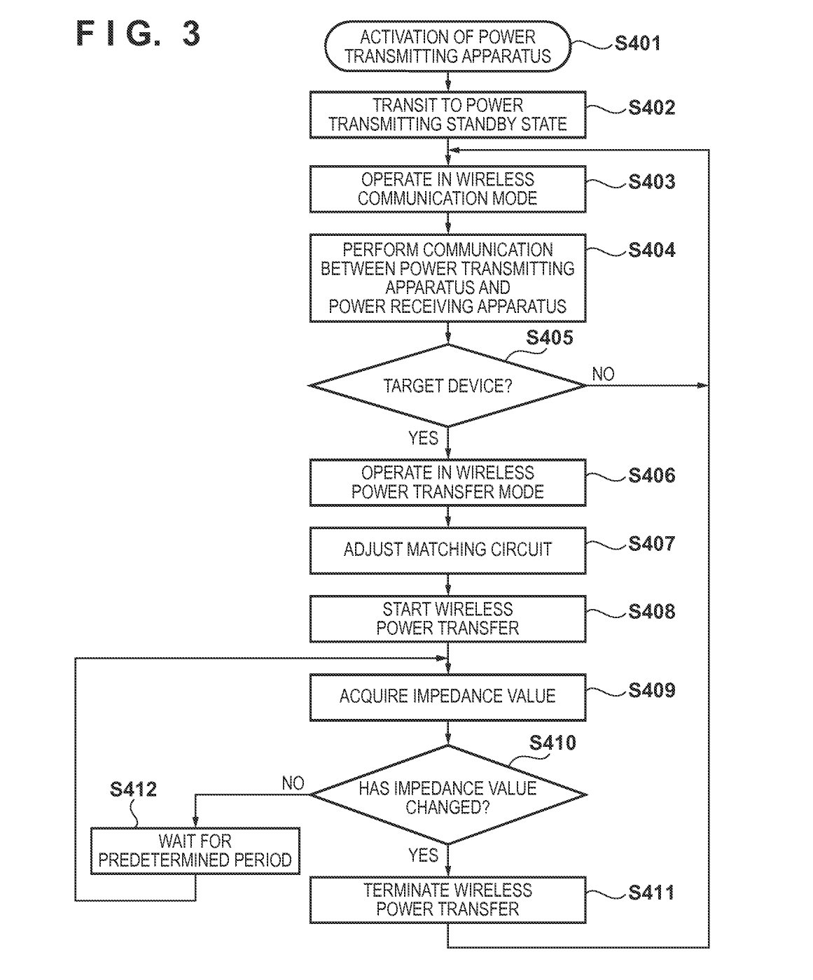

FIG. 3 is a flowchart illustrating control of the power transmitting apparatus. The operation of the power transmitting apparatus will be described with reference to FIG. 3.

The power transmitting apparatus (for example, the power transmitting apparatus 301) is turned on, and activated (step S401). The power transmitting apparatus transits to a power transmitting standby state which enables the power transmitting apparatus to transmit power to the power receiving apparatus (for example, the power receiving apparatus A 302) when the power receiving apparatus is placed (step S402).

The power transmitting apparatus operates in a wireless communication mode (step S403). The wireless communication mode indicates a state in which the power transmitting apparatus can wirelessly communicate with the power receiving apparatus having the wireless communication function using the wireless communication function of its own. Note that the wireless communication mode of the power receiving apparatus indicates a condition in which wireless communication to a power transmitting apparatus having a wireless communication function can be executed by a wireless communication function of the power receiving apparatus. When the power receiving apparatus is placed on the power transmitting apparatus, the power transmitting apparatus wirelessly communicates with the power receiving apparatus, thereby transmitting and receiving device information (step S404).

The power transmitting apparatus performs device authentication of the power receiving apparatus placed on the power transmitting apparatus, and determines whether the power receiving apparatus is a power receiving apparatus (target device) as a power transmitting target (step S405). If the power receiving apparatus is not a target device (NO in step S405), the process returns to step S403; otherwise (YES in step S405), the power transmitting apparatus operates in a wireless power transfer mode (step S406). This wireless power transfer mode indicates a condition of the power transmitting apparatus which can transfer power from the power transmitting apparatus to the power receiving apparatus by using the wireless power transfer function. Note that a power transfer mode of the power receiving apparatus indicates a condition of the power receiving apparatus which can receive power transmitted from the power transmitting apparatus by using the wireless power transfer function.

Note that a plurality of power receiving apparatuses may be placed on the power transmitting apparatus, as shown in FIG. 2. In this case, in the above-described processing of determining whether the receiving apparatus is a target device, information for deciding priorities to determine a power receiving apparatus to be charged and supplied with power may be used. The information for deciding priorities may be based on, for example, the IDs of the devices or a result decided according to predetermined information by performing communication between the power receiving apparatuses.

The power transmitting apparatus adjusts the matching circuit to allow high-efficiency wireless power transfer between the power transmitting apparatus and the power receiving apparatus (step S407). The matching circuit is adjusted so that wireless power transfer between the power transmitting apparatus and the power receiving apparatus as a power transmitting target decided in step S405 is performed at high efficiency. Adjustment of the matching circuit makes it possible to adapt to the state of the power receiving apparatus placed on the power transmitting apparatus, thereby allowing high-efficiency wireless power transfer between the power transmitting apparatus and the power receiving apparatus. With respect to adjustment of the matching circuit, when only the power transmitting apparatus has a matching circuit adjustment function, only the matching circuit of the power transmitting apparatus may be adjusted. When both the power transmitting apparatus and the power receiving apparatus have a matching circuit adjustment function, both the matching circuits of the power transmitting apparatus and power receiving apparatus may be adjusted.

The power transmitting apparatus starts wireless power transfer (step S408).

After the start of wireless power transfer, whether a new object is placed on the power transmitting apparatus is detected. In the first embodiment, by using the above-described antenna impedance detection function, whether a new object is placed on the power transmitting apparatus is detected based on an impedance value of the antenna of the power transmitting apparatus.

More specifically, the power transmitting apparatus acquires the impedance value of the antenna of the power transmitting apparatus (step S409). The power transmitting apparatus determines whether the impedance value has changed (step S410). If the impedance value has changed (YES in step S410), the power transmitting apparatus determines that a new power receiving apparatus (for example, the power receiving apparatus B 303) has been placed on the power transmitting apparatus, and terminates wireless power transfer (step S411). After that, the power transmitting apparatus returns to the wireless communication mode (step S403).

On the other hand, if the impedance value has not changed (NO in step S410), the power transmitting apparatus waits for a predetermined period (step S412). After that, the power transmitting apparatus acquires the impedance value again (step S409). In this way, the power transmitting apparatus confirms, at intervals of the predetermined period, whether a new object has been placed on the power transmitting apparatus. This control operation enables the power transmitting apparatus to charge a plurality of power receiving apparatuses.

In the first embodiment, a case in which the impedance value which changes when the power receiving apparatus B is placed on the power transmitting apparatus is detected has been explained by assuming the arrangement shown in FIG. 2. However, the impedance value may change not only when the power receiving apparatus B is placed but also, for example, when a foreign substance is placed on the power receiving apparatus, and when the power receiving apparatus placed on the power transmitting apparatus is removed. In these cases, the power transmitting apparatus also terminates wireless power transfer (step S411).

As described above, by controlling the power transmitting apparatus, when the power receiving apparatus B is newly placed on the power transmitting apparatus during wireless power transfer between the power transmitting apparatus and the power receiving apparatus A, the power transmitting apparatus detects it. In this case, the power transmitting apparatus temporarily stops wireless power transfer with the power receiving apparatus A, performs device authentication again, and adjusts the matching circuit while the power receiving apparatuses A and B are placed on the power transmitting apparatus, thereby restarting wireless power transfer.

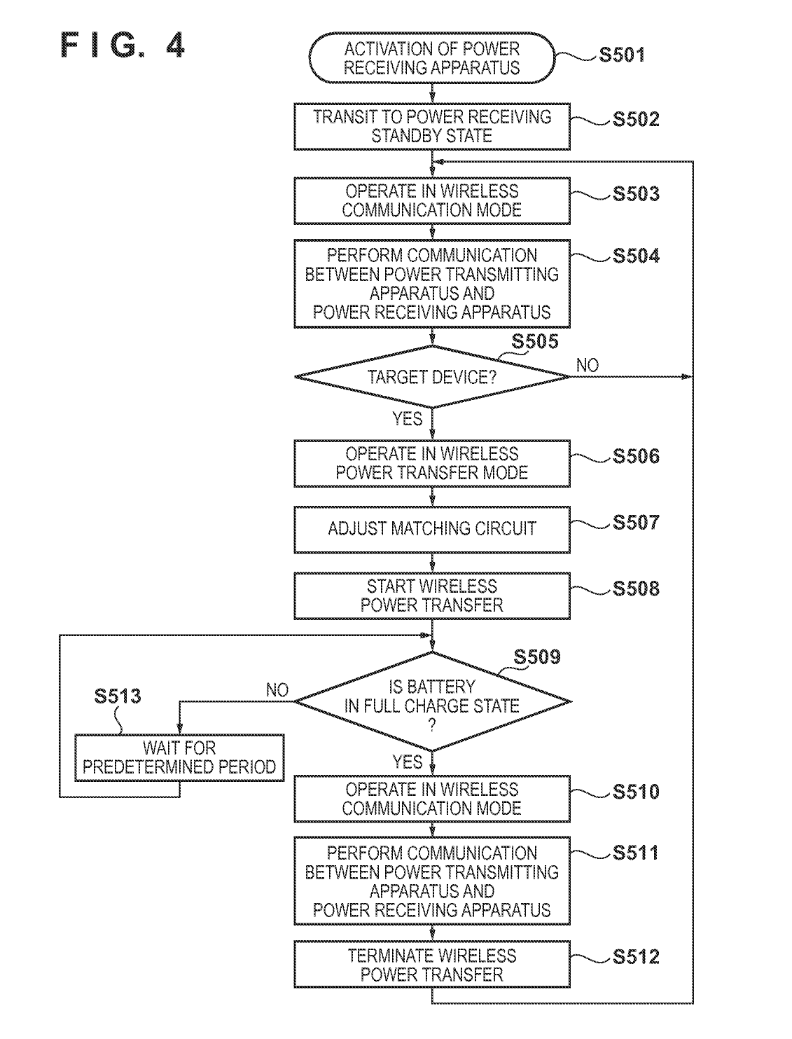

FIG. 4 is a flowchart illustrating control of the power receiving apparatus. The operation of the power receiving apparatus will be described with reference to FIG. 4.

The power receiving apparatus is turned on, and activated (step S501). The power receiving apparatus transits to a power receiving standby state which enables the power receiving apparatus to receive power from the power transmitting apparatus (step S502). The power receiving apparatus operates in a wireless communication mode (step S503). When the power receiving apparatus itself is placed on the power transmitting apparatus, it wirelessly communicates with the power transmitting apparatus, thereby transmitting and receiving device information (step S504).

The power receiving apparatus performs device authentication, and determines whether the power transmitting apparatus on which the power receiving apparatus has been placed is a target device having no problem as a power receiving target device (step S505).

Note that a plurality of power receiving apparatuses may be placed on the power transmitting apparatus, as shown in FIG. 2. In this case, in the above-described processing of determining whether the power transmitting apparatus is a target device, information for deciding priorities to determine a power receiving apparatus to be charged and supplied with power by the power transmitting apparatus may be used. The information for deciding priorities may be based on, for example, the IDs of the devices or a result decided according to predetermined information by performing communication between the power receiving apparatuses.

If, for example, the power receiving apparatus determines that its priority of charging and power supply is lower than those of other power receiving apparatuses, it determines that the power transmitting apparatus is not a target device. If the power receiving apparatus determines that its priory of charging and power supply is higher than those of other power receiving apparatuses, and the self apparatus is a target device to be charged and supplied with power, the power receiving apparatus determines that the power transmitting apparatus is a target device.

If the power receiving apparatus determines that the power transmitting apparatus is not a target device (NO in step S505), the process returns to step S503; otherwise (YES in step S505), the power receiving apparatus operates in a wireless power transfer mode (step S506).

The power receiving apparatus adjusts the matching circuit to allow high-efficiency wireless power transfer between the power transmitting apparatus and the power receiving apparatus (step S507). The power receiving apparatus starts wireless power transfer (step S508). After that, the power receiving apparatus determines whether the charge state of the battery is a predetermined charge state (full charge state) (step S509). If the power receiving apparatus determines that the battery is in the full charge state (YES in step S509), it operates in the wireless communication mode (step S510). The power receiving apparatus then wirelessly communicates with the power transmitting apparatus (step S511). The power receiving apparatus notifies the power transmitting apparatus that it is not necessary to transfer power any more, and terminates wireless power transfer (step S512).

Note that the predetermined charge state need not be the full charge state. For example, the predetermined charge state may be a charge state in which an amount of charge is equal to or larger than a predetermined threshold and it is not necessary to charge the battery any more.

On the other hand, if the power receiving apparatus determines that the battery is not in the full charge state (NO in step S509), the power receiving apparatus waits for a predetermined period (step S513). The power receiving apparatus determines again whether the battery is in the full charge state (step S509).

By executing the above-described control operation, even if there are a plurality of power receiving apparatuses as power transmitting targets, it is possible to appropriately charge the power receiving apparatuses.

As described above, according to the first embodiment, in the wireless power transfer system having the wireless communication function of charging and supplying power to a plurality of power receiving apparatuses from a power transmitting apparatus, it is possible to charge and supply power to the plurality of power receiving apparatuses by appropriately controlling the power transmitting apparatus and the power receiving apparatuses.

### Second Embodiment

In the second embodiment, a case will be described in which each of a power transmitting apparatus and a power receiving apparatus has a coil which is commonly used for NFC serving as a wireless communication function and a wireless power transfer function using the magnetic resonance method. Commonly using a coil produces effects of downsizing a product and reducing the cost. When a coil is commonly used, the single coil receives electromagnetic waves used in wireless communication and those used in wireless power transfer. Note that the wireless communication function and the wireless power transfer function described in the embodiment use at least part of the same frequency band.

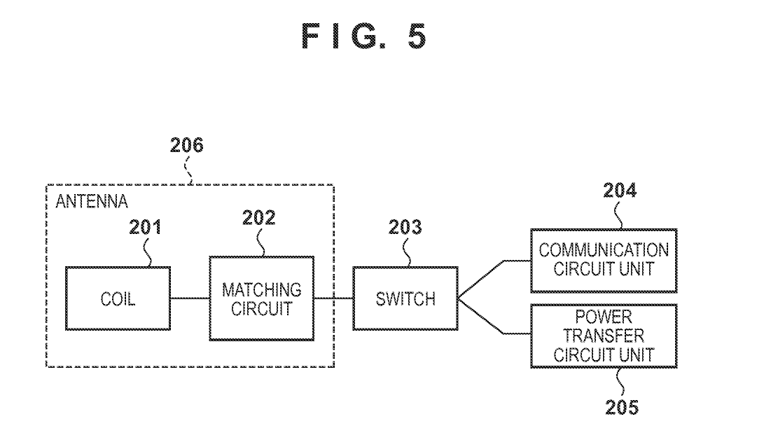

FIG. 5 shows the circuit arrangement of each of the power receiving apparatus and the power transmitting apparatus according to the second embodiment.

Reference numeral 201 denotes a coil for receiving electromagnetic waves in wireless communication by NFC and power transfer by the magnetic resonance method; and 202, a matching circuit. The coil 201 and the matching circuit 202 are combined to implement an antenna 206.

The matching circuit 202 has a function of changing or adjusting the matching circuit. More specifically, the matching circuit 202 uses circuit elements (for example, a resistor, capacitor, and inductor), and controls to change or adjust the constants of the resistor, capacitor and inductor. Reference numeral 204 denotes a communication circuit unit which processes, as communication, electromagnetic waves input from the antenna 206 and used in wireless communication.

Reference numeral 205 denotes a power transfer circuit unit which processes, as power transfer, electromagnetic waves input from the antenna 206 and used in wireless power transfer; and 203, a switch (switching unit) for switching between the communication circuit unit 204 and the power transfer circuit unit 205, which are connected to the antenna 206. The above arrangement makes it possible to separate power input from the antenna 206 into a wireless power transfer circuit unit (the power transfer circuit unit 205) and a wireless communication circuit unit (the communication circuit unit 204) without requiring any complicated circuit.

In each of the power transmitting apparatus and the power receiving apparatus, which has the circuit arrangement shown in FIG. 5, however, when the situation shown in FIG. 2 occurs, the electromagnetic waves of high power used in wireless power transfer may be input to the wireless communication circuit unit unless the switch 203 is appropriately switched. In this case, the wireless communication circuit unit may be damaged.

To solve this problem, in the second embodiment, the following function is incorporated in the power receiving apparatus, and controlled. Especially, in the second embodiment, the power receiving apparatus includes a power amount detection unit for detecting whether power input to the antenna 206 is high power equal to or higher than a predetermined value.

In the second embodiment, a flowchart illustrating control of the power transmitting apparatus is the same as that shown in FIG. 3 of the first embodiment and a description thereof will be omitted.

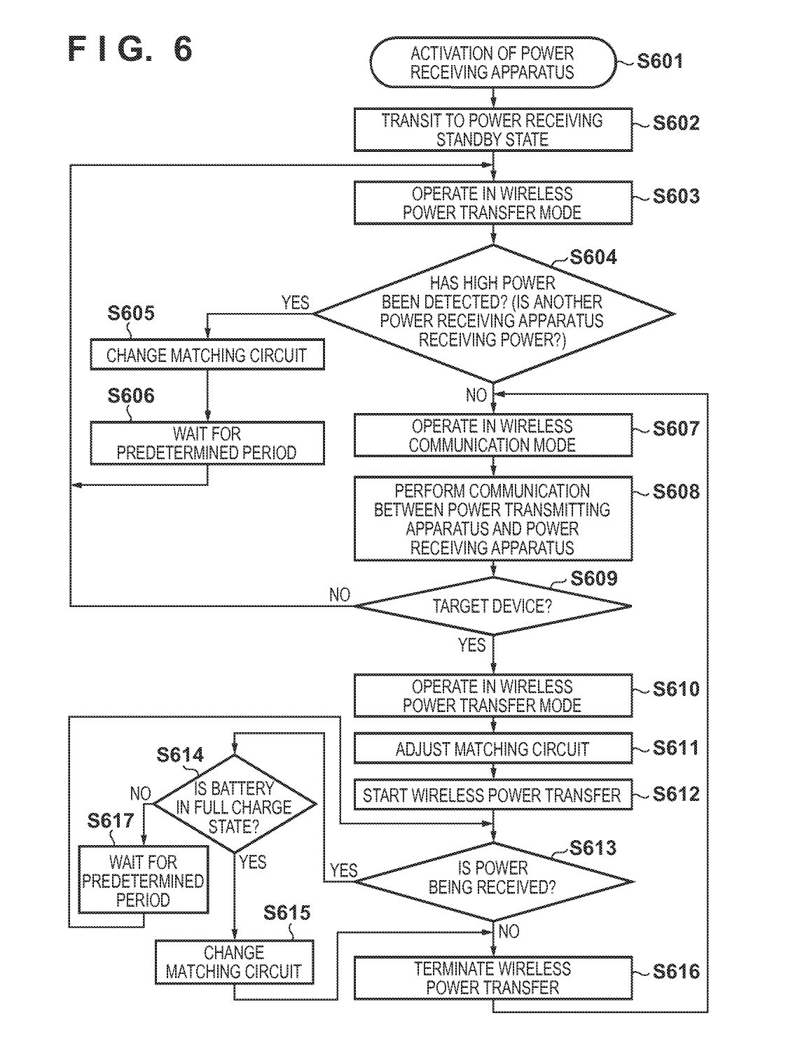

FIG. 6 is a flowchart illustrating control of the power receiving apparatus. In the second embodiment, the operation of a power receiving apparatus B 303 in the arrangement shown in FIG. 2 will be described with reference to FIG. 6.

The power receiving apparatus is turned on, and activated (step S601). The power receiving apparatus transits to the power receiving standby state which enables the power receiving apparatus to receive power from the power transmitting apparatus (step S602). The power receiving apparatus operates in the wireless power transfer mode (step S603). When the power receiving apparatus operates in the wireless power transfer mode, it switches the switch 203 shown in FIG. 5 to the power transfer circuit unit 205 for processing electromagnetic waves used in power transfer.

The power receiving apparatus determines whether power of electromagnetic waves input to the antenna 206 is high power equal to or higher than a predetermined value (power determination). If the power receiving apparatus determines that the power of the electromagnetic waves input to the antenna 206 is high power (equal to or higher than the predetermined value) (YES in step S604), it changes the matching circuit 202 (step S605). The power receiving apparatus waits for a predetermined period (step S606). After that, the power receiving apparatus returns to the wireless power transfer mode again (step S603).

The purpose of step S603 is to prevent the communication circuit unit from being damaged when the power receiving apparatus B is moved closer during wireless power transfer between a power transmitting apparatus 301 and a power receiving apparatus A, as shown in FIG. 2 and, if the power receiving apparatus B is in the wireless communication mode, high power input from the antenna is unwantedly input to the communication circuit unit. That is, in step S603, a method of setting an impedance value, which does not cause high power to enter the communication circuit unit of the power receiving apparatus, by changing or adjusting the matching circuit may be used. Immediately after the power receiving apparatus is turned on, and activated, by operating in the wireless power transfer mode (not operating the wireless communication mode) or by changing or adjusting the matching circuit, the power receiving apparatus can prevent the communication circuit unit from being damaged. Note that the power transfer circuit unit for executing wireless power transfer is used in the wireless power transfer mode, and the communication circuit unit for executing wireless communication is used in the wireless communication mode.

Especially if the power receiving apparatus detects in step S604 that the power of the electromagnetic waves input to the antenna is high power, this means that the power transmitting apparatus 301 is wirelessly transferring power to another power receiving apparatus (the power receiving apparatus A in the second embodiment), as shown in FIG. 2.

Changing the matching circuit of the power receiving apparatus B in step S605 has two purposes. One of the purposes is to prevent electromagnetic waves used in wireless power transfer (in the second embodiment, wireless power transfer from the power transmitting apparatus 301 to the power receiving apparatus A) in progress from being input to the power receiving apparatus B. The other purpose is to cause the power transmitting apparatus 301 to stop wireless power transfer from the power transmitting apparatus 301 to the power receiving apparatus A by changing the matching circuit of the power receiving apparatus B to change the impedance of the antenna from the viewpoint of the power transmitting apparatus 301, and detecting the change in impedance value in the determination processing in step S410 of FIG. 3.

After wireless power transfer from the power transmitting apparatus to the power receiving apparatus A is stopped, the power transmitting apparatus enters the state in step S403 of FIG. 3 and the power receiving apparatus enters the state in step S607, thereby performing wireless communication between the power transmitting apparatus and the power receiving apparatuses A and B. With this processing, it is only necessary to determine again the power receiving apparatus to which power is wirelessly transferred from the power transmitting apparatus.

When changing the matching circuit at this time, therefore, it is only necessary to change the impedance of the antenna of the power transmitting apparatus, and prevent electromagnetic waves from being input to the power receiving apparatus B. As a method of changing the matching circuit, for example, constants which generate a resonance frequency different from the frequency of electromagnetic waves used in wireless power transfer from the power transmitting apparatus to the power receiving apparatus A may be set or a matching circuit portion may be opened.

If the power receiving apparatus determines in step S604 that the power of the electromagnetic waves input to the antenna 206 is not high power (that is, the power is lower than the predetermined value) (NO in step S604), this means that the power transmitting apparatus wirelessly transfers no power to the other power receiving apparatus, and thus the power receiving apparatus operates in the wireless communication mode (step S607). When the power receiving apparatus operates in the wireless communication mode, it switches the switch 203 shown in FIG. 5 to the communication circuit unit 204 for processing the electromagnetic waves used in communication. Furthermore, the matching circuit 202 is changed or adjusted by, for example, changing the constants of the resistor, capacitor, and inductor to have a circuit arrangement suitable for wireless communication.

The power receiving apparatus wirelessly communicates with the power transmitting apparatus, thereby transmitting and receiving device information (step S608). The power receiving apparatus performs device authentication, and determines whether the power transmitting apparatus on which the power receiving apparatus B has been placed is a target device having no problem as a power receiving target device (step S609). If it is determined that the power transmitting apparatus is not a target device (NO in step S609), the process returns to step S603; otherwise (YES in step S609), the power receiving apparatus operates in the wireless power transfer mode (step S610).

The power receiving apparatus adjusts the matching circuit so as to allow high-efficiency wireless power transfer between the power transmitting apparatus and the power receiving apparatus (step S611). This processing adjusts the matching circuit to allow high-efficiency wireless power transfer between the power receiving apparatus B and the power transmitting apparatus as a power transmitting source decided in step S609. Adjustment of the matching circuit makes it possible to adapt to the state of the power receiving apparatus placed on the power transmitting apparatus, thereby allowing high-efficiency wireless power transfer between the power transmitting apparatus and the power receiving apparatus.

The power receiving apparatus starts wireless power transfer (step S612). After the start of wireless power transfer from the power transmitting apparatus to the power receiving apparatus, the power receiving apparatus determines whether it is receiving power from the power transmitting apparatus (step S613). If the power receiving apparatus determines that it is receiving power (YES in step S613), it determines whether the charge state of a battery is a predetermined charge state (full charge state) (step S614). If the power receiving apparatus determines that the battery is in the full charge state (YES in step S614), the power receiving apparatus (power receiving apparatus B) changes the matching circuit of its own (step S615).

When the matching circuit of the power receiving apparatus B is changed in step S615, the impedance value of the antenna of the power transmitting apparatus also changes. As shown in FIG. 3, the power transmitting apparatus detects the change in impedance value (step S410), and terminates wireless power transfer (step S411). At this time, the matching circuit is changed by, for example, setting constants which generate a resonance frequency different from the frequency of electromagnetic waves used in wireless power transfer from the power transmitting apparatus to the power receiving apparatus A, or opening a matching circuit portion.

On the other hand, if the power receiving apparatus determines that the battery is not in the full charge state (NO in step S614), the power receiving apparatus waits for a predetermined period (step S617). The power receiving apparatus then returns to step S613.

On the other hand, if the power receiving apparatus determines that it is receiving no power (NO in step S613), it terminates wireless power transfer (step S616). This may correspond to, for example, a case in which the power transmitting apparatus detects a change in impedance value (step S410), and terminates power transmission (step S411), as shown in FIG. 3.

As described above, according to the second embodiment, in an arrangement in which a coil is commonly used as the coil of NFC serving as a wireless communication function and the coil of a wireless power transfer function using the magnetic resonance method, it is possible to perform wireless communication and wireless power transfer with a plurality of power receiving apparatuses without damaging the communication circuit units.

In the wireless power transfer system, if a coil is commonly used in wireless power transfer and wireless communication, it is possible to perform wireless power transfer and wireless communication without requiring any complicated circuit to separate electromagnetic waves input from the coil. Note that the present invention is applicable not only within the range of the magnetic resonance method but also to a wireless power transfer system of another method using coupling between coils or coupling between electrodes. Further, an antenna used for the wireless communication function and the wireless power transfer function may be a dipole antenna, a monopole antenna, an inverted F antenna, and the like. Further, the invention is applicable not only within the range of NFC but also to another wireless communication method, such as Bluetooth and wireless LAN. Further, a frequency band used by the wireless communication function and the wireless power transfer function may be different a frequency band.

### INDUSTRIAL APPLICABILITY

The present invention relates to a wireless power transfer system for wirelessly transferring power and, more particularly, to control of a power transmitting apparatus having a wireless communication function and a power receiving apparatus having a wireless communication function.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-172659, filed Aug. 22, 2013, which is hereby incorporated by reference herein in its entirety.

1.-16. (canceled)

17. A power transmitting apparatus for wirelessly transmitting power, comprising:
an antenna which performs power transmission;
a detection unit configured to detect an impedance value of the antenna while performing power transmission to a first power receiving apparatus; and
a control unit configured to, when the detection unit detects a change in the impedance value, stop the power transmission to the first power receiving apparatus.

18. The apparatus according to claim 17, wherein
the detection unit detects the impedance value of the antenna at intervals of a predetermined period.

19. The apparatus according to claim 17, wherein
the detection unit inputs power to the antenna, causes a direction coupler to acquire an amount of power reflected by the antenna, and detects an impedance value from the amount of power.

20. The apparatus according to claim 17, further comprising
a communication unit configured to wirelessly communicate with a power receiving apparatus,
wherein when a power receiving apparatus which wirelessly communicates with the communication unit is detected, the control unit controls the antenna to start power transmission with the power receiving apparatus which wirelessly communicates with the communication unit.

21. The apparatus according to claim 17, further comprising:
a determination unit configured to determine, based on communication, whether a second power receiving apparatus that is different from the first power receiving apparatus exists or not after the control unit stops power transmission,
wherein the control unit controls to start power transmission to the first power receiving apparatus and the second power receiving apparatus in a case where the determination unit determines that the second power receiving apparatus exists.

22. The apparatus according to claim 17, further comprising:
an adjusting unit configured to adjust a resonance frequency of the antenna;
wherein the control unit restarts power transmission in a case where the power transmission is stopped and the adjustment unit adjusts the resonance frequency of the antenna.

23. A power receiving apparatus for wirelessly receiving power, comprising:
an antenna;
a communication unit configured to perform wireless communication using the antenna;
a power receiving unit configured to wirelessly receive power using the antenna;
a detection unit configured to detect power transmission of a power transmitting apparatus to another power receiving apparatus; and
a limiting unit configured to limit, in a case where the detection unit detects power transmission of the power transmitting apparatus to the other power receiving apparatus, power input to the communication unit which is supplied by the power transmission of the power transmitting apparatus to the other power receiving apparatus;
wherein the limiting unit deactivates the limiting power input to the communication unit, in a case where the detection unit does not detect power transmission of the power transmitting apparatus to the other power receiving apparatus after the limiting power input to the communication unit,
wherein the communication unit performs communication with the power transmitting apparatus for authentication after the deactivation of limiting power input to the communication apparatus, and
wherein the power receiving unit receives power from the power transmission apparatus in response to the communication for authentication.

24. The apparatus according to claim 23, wherein the limiting unit limits power input to the communication unit which is supplied by the power transmission of the power transmitting apparatus to the other power receiving apparatus by causing the antenna not to connect to the communication unit and causing the antenna to connect to the power receiving unit.

25. The apparatus according to claim 23, further comprising:
an adjusting unit configured to adjust a resonance frequency of the antenna based on the communication for authentication with the power transmitting apparatus by the communication unit;
wherein the power receiving unit starts receiving power after the adjustment by the adjusting unit.

26. The apparatus according to claim 23, further comprising:
a battery configured to store power that is received by the power receiving unit;
an adjusting unit configured to adjust a resonance frequency of the antenna in a case where the battery is in a full-charge state,
wherein the power receiving unit ends receiving power after the adjusting unit adjusts the resonance frequency of the antenna.

27. A control method for a power transmitting apparatus for wirelessly transmitting power, which includes an antenna configured to perform wireless power transfer, the method comprising:
detecting an impedance value of the antenna while performing power transmission to a first power receiving apparatus; and
stopping, when a change in the impedance value is detected in the detection, the power transmission to the first power receiving apparatus.

28. A control method for a power receiving apparatus for wirelessly receiving power, which includes an antenna, a communication unit configured to perform wireless communication using the antenna, and a power receiving unit configured to wirelessly receive power using the antenna, the method comprising:
detecting power transmission of a power transmitting apparatus to another power receiving apparatus;
limiting, in a case where power transmission of the power transmitting apparatus to the other power receiving apparatus is detected in the detecting, power input to the communication unit which is supplied by the power transmission of the power transmitting apparatus to the other power receiving apparatus; and
deactivating the limiting power input to the communication unit, in a case where power transmission of the power transmitting apparatus to the other power receiving apparatus is not detected after the limiting power input to the communication unit,
wherein the communication unit performs communication with the power transmitting apparatus for authentication after the deactivation of limiting power input to the communication apparatus, and
wherein the power receiving unit receives power from the power transmission apparatus in response to the communication for authentication.

29. A computer-readable storage medium storing a program for causing a computer to control a power transmitting apparatus for wirelessly transmitting power which includes an antenna configured to perform power transmission, the program causing the computer to function as
a detection unit configured to detect an impedance value of the antenna while performing power transmission to a first power receiving apparatus; and
a control unit configured to, when the detection unit detects a change in the impedance value, stop the power transmission to the first power receiving apparatus.

30. A computer-readable storage medium storing a program for causing a computer to control a power receiving apparatus for wirelessly receiving power which includes an antenna, the program causing the computer to function as
a communication unit configured to perform wireless communication using the antenna;
a power receiving unit configured to wirelessly receive power using the antenna;
a detection unit configured to detect power transmission of a power transmitting apparatus to another power receiving apparatus; and
a limiting unit configured to limit, in a case where the detection unit detects power transmission of the power transmitting apparatus to the other power receiving apparatus, power input to the communication unit which is supplied by the power transmission of the power transmitting apparatus to the other power receiving apparatus;
wherein the limiting unit deactivates the limiting power input to the communication unit, in a case where the detection unit does not detect power transmission of the power transmitting apparatus to the other power receiving apparatus after the limiting power input to the communication unit,
wherein the communication unit performs communication with the power transmitting apparatus for authentication after the deactivation of limiting power input to the communication apparatus, and
wherein the power receiving unit receives power from the power transmission apparatus in response to the communication for authentication.
